(19) United States
(12) Patent Application Publication
(10) Pub. No.: US 2003/0096726 A1
(43) Pub. Date: May 22, 2003

(54) Concentrated surfactant blends

(75) Inventors: George A Smith, Austin, TX (US); Raeda M. Smadi, Austin, TX (US)

Correspondence Address: Russell R. Stolle, Huntsman Corporation, P. O. Box 15730, Austin, TX, 78761, US

(73) Assignee: Huntsman Petrochemical Corporation, Austin, TX

(21) Appl. No.: 10/196,998

(22) Filed: Jul. 16, 2002

Related U.S. Application Data
(63) Continuation-in-part of application No. 09/479,436, filed on Jan. 7, 2000.
(63) Continuation-in-part of application No. 09/603,168, filed on Jun. 26, 2000.
(60) Provisional application No. 60/115,408, filed on Jan. 11, 1999.
(60) Provisional application No. 60/139,441, filed on Jun. 15, 1999.
(60) Provisional application No. 60/141,951, filed on Jun. 30, 1999.

(51) Int. Cl. C11D 17/00

(52) U.S. Cl. 510/424; 510/499; 510/502

(57) ABSTRACT

Concentrated anionic liquid surfactant compositions containing mixtures of anionic and nonionic surfactants. The concentrated liquid surfactant compositions may be substantially isotropic, non-flammable and have relatively low viscosity.

### CROSS-REFERENCES TO RELATED APPLICATIONS

This application is a continuation-in-part of U.S. applications Ser. Nos. 09/479,436 filed Jan. 7, 2000 and 09/603,168 filed Jun. 26, 2000 respectively, and also claims priority to applications serial Nos. 60/115,408 filed Jan. 11, 1999, 60/139,441 filed Jun. 15, 1999, and 60/141,951 filed Jun. 30, 1999.

### FIELD OF THE INVENTION

The present invention relates generally to anionic surfactant compositions and, more particularly, to concentrated liquid mixtures of anionic and nonionic surfactants. Specifically, this invention relates to concentrated liquid surfactant compositions containing anionic and nonionic surfactants that may have relatively low viscosity and/or that may be substantially isotropic.

### DESCRIPTION OF RELATED ART

Multiple surfactants are often employed in formulated laundry detergents. Anionic surfactants have been found to give good performance on polar or particulate types of soils, and help to prevent soil redeposition. In addition, anionic surfactants may be used to control formulation viscosity. Nonionic surfactants have been found to give good detergency on nonpolar soils and may be used to impart electrolyte or an increased level of tolerance to water hardness.

Typical anionic surfactants used in laundry include, without limitation, linear alkyl benzene sulfonates, alkyl sulfates, ether sulfates, secondary alkyl sulfates, α-olefin sulfonate, phosphate esters, sulfosuccinates, isethionates, carboxylates, etc. Most of these surfactants are typically sold in the form of a sodium salt.

One common type of anionic surfactant, linear alkylbenzene sulfonate (“LAS”), is widely used in commercial cleaning products due to its effectiveness as a surfactant or detergent, ease of biodegradation, and relative low cost. Typically, linear alkylbenzene sulfonates are produced via sulfonation of linear alkylbenzene intermediates.

Linear alkylbenzene is typically manufactured on an industrial scale using one of three commercial processes which differ from one another primarily by virtue of the catalyst system employed. In this regard, one process employs an aluminum trichloride catalyst, another process uses a hydrogen fluoride catalyst while the third process uses solid alkylation catalyst. The three processes result in linear alkylbenzene products with different phenyl isomer distributions. For example, a typical phenyl isomer distribution for products of the aluminum trichloride process is about 30% 2-phenyl isomer and about 22% 3-phenyl isomer. In contrast, a typical phenyl isomer distribution for products of the hydrogen fluoride process is about 20% 2-phenyl isomer and about 20% 3-phenyl isomer, although reported values may differ. The product of the aluminum trichloride process, which is relatively high in 2-phenyl isomer content, is often referred to as “high 2-phenyl” linear alkylbenzene, whereas the product of the hydrogen fluoride process, which is relatively low in 2-phenyl isomer content, is often referred to as “low 2-phenyl” linear alkylbenzene.

The sulfonates of linear alkylbenzenes are known to exhibit different physical properties depending upon the position of the aromatic group on the alkyl chain. Therefore, high 2-phenyl linear alkylbenzene sulfonates have physical properties that differ from low 2-phenyl linear alkylbenzene sulfonates. For example, high 2-phenyl linear alkylbenzene sulfonates typically have a higher solubility in aqueous media than do low 2-phenyl linear alkylbenzene sulfonates. Furthermore, an aqueous solution comprising a high 2-phenyl linear alkylbenzene sulfonate may exhibit a higher viscosity than an aqueous solution comprising a low 2-phenyl linear alkylbenzene sulfonate. In cases where maximum solubility of linear alkylbenzene sulfonate in an aqueous detergent formulation is of concern, a product containing a relatively high percentage of compounds in which the aromatic substituent is in the 2 or 3 position and a correspondingly smaller percentage of isomers in which the aromatic substituent is positioned centrally with respect to the alkyl chain may be advantageous.

Hydrotropes, such as sodium xylene sulfonate, may be added to improve solubility of low 2-phenyl linear alkylbenzene sulfonates. As used herein, the term “hydrotrope” is defined to be a compound that has the property of increasing the aqueous solubility of various slightly soluble organic chemicals.

In general, anionic surfactants are sold in the form of sodium, potassium or amine salts. The salts tend to be solid materials at room temperature, so they are typically sold as aqueous solutions. Because of gel phase formation, surfactant concentrations between about 20% and about 40% by weight of total weight of a surfactant solution are what are commonly employed. Above concentrations of about 40% active surfactant, anionic surfactant solutions typically form viscous gels or pastes. To reduce viscosity, solvents such as ethanol or isopropanol are often added. However, such components are volatile organic components (“VOCs”) and tend to form flammable mixtures.

In a further effort to form surfactant compositions having higher activities and lower viscosities, various other additives have been conventionally employed, including alkyl polyglycosides and alkali metal chlorides. However, such compositions also include water and amphoteric surfactant, thus limiting the activity of the surfactant mixture. In still other cases, compositions including concentrated lamellar or other types of liquid crystals have been employed. However, compositions are typically not isotropic at room temperature and have activities limited to about 70%.

### SUMMARY OF THE INVENTION

The present invention provides improved surfactant compositions. We have found that concentrated liquid surfactant compositions which are both isotropic and non-flammable may be formulated using anionic and nonionic surfactants. The disclosed liquid surfactant compositions may be advantageously employed for a number of uses, including in the formulation of any surfactant or detergent composition in which one or more anionic surfactant/s are desired to be present as a surfactant component. Examples of such compositions include, without limitation, heavy duty laundry detergents, herbicide emulsifiers, hard surface cleaners, bathroom cleaners, all purpose cleaners, dishwashing detergents, car wash detergents, janitorial cleaners, light duty liquid detergents, etc. The disclosed concentrated liquid surfactant blends may be useful in the formulation of other compositions as well including, but not limited to, those used in coating applications, emulsion polymerization, pigment dispersions, wetting agents and the like.

In the disclosed compositions, concentrated liquid surfactant mixtures containing one or more anionic surfactants may be formulated using one or more nonionic surfactants as a solvent system. In one preferred embodiment, the disclosed liquid surfactant compositions contain substantially no water, although water may be present in other embodiments, if so desired. Using this approach, substantially isotropic liquid surfactant mixtures having relatively low viscosity at up to about 100% active surfactant content may be surprisingly prepared. Advantageously, a composition according to the invention avoids the use of flammable solvents and minimizes or eliminates the total water content necessary in a blend according to the invention. Such elimination or minimization of water translates to reduced shipping charges, which savings can be passed on to industrial customers, which may ultimately be passed on to the consumer level. Furthermore, the disclosed compositions may be formulated to achieve one or more of these advantageous properties without the use of volatile organic compounds (“VOCs”), and thus may be referred to as substantially VOC free or as containing substantially no VOCs. In addition, another embodiment of the disclosed compositions contains substantially no liquid crystal constituents, and thus may be described as being substantially liquid crystal free. Still further, another embodiment of the disclosed compositions contains substantially no microemulsion constituents, and thus may be described as being substantially microemulsion free.

As used herein, relatively low viscosities include any viscosity lower than a viscosity of a comparable liquid anionic surfactant solution consisting of no other additional ingredients (i.e., no ingredients other than water and electrolyte), and lacking the disclosed mixture of nonionic and anionic surfactants. In one preferred embodiment, the disclosed concentrated liquid surfactant compositions may be advantageously formulated to have viscosities at 25° C. of less than about 2000 centipoise (cps). According to an alternate form of the invention, a concentrated liquid surfactant is provided having a viscosity of less than 1500 cps. According to an alternate form of the invention, a concentrated liquid surfactant is provided having a viscosity of less than 1000 cps. According to another alternate form of the invention, a concentrated liquid surfactant is provided having a viscosity of less than 800 cps. According to yet another alternate form of the invention, a concentrated liquid surfactant is provided having a viscosity of less than 600 cps. In an alternate embodiment, viscosity of the disclosed liquid compositions at 25° C. may range from about 2000 cps to about 5000 cps, including every cps therebetween, alternatively from about 1500 cps to about 2000 cps, including every cps therebetween, alternatively from about 1000 cps to about 1500 cps, including every cps therebetween, and alternatively from about 500 cps to about 800 cps, including every cps therebetween.

In one respect, the present invention provides liquid surfactant compositions that include at least one anionic surfactant and at least one nonionic surfactant. A liquid surfactant composition according to the invention has an active surfactant content of any amount between 40.00% and 99.99% by weight based on the total weight of the composition, and in one preferred form of the invention is substantially isotropic at a temperature of 25° C., and contains substantially no volatile organic components.

In another respect, disclosed is a liquid surfactant composition, including at least one anionic surfactant and at least one nonionic surfactant. The anionic surfactant may be at least one selected from the group consisting of: alkyl benzene sulfonate, alkyl sulfate, alcohol sulfate, ether sulfate, secondary alkyl sulfate, α-olefin sulfonate, phosphate ester, sulfosuccinate, isethionate, and carboxylate, or a mixture thereof; and the nonionic surfactant may be at least one of nonylphenol ethoxylate, alcohol ethoxylate, EO-PO block copolymer, including mixtures thereof. A liquid surfactant composition according to the invention preferably has an active surfactant content of greater than 40% by weight based upon the total weight of the composition, is preferably substantially isotropic at a temperature of 25° C., preferably has a pH of greater than 7, preferably has a viscosity of less than about 2000 centipoise at 25° C., is preferably non-flammable, and contains substantially no volatile organic components.

In yet another respect, the present invention provides a method for preparing a liquid surfactant composition, including combining at least one nonionic surfactant with at least one anionic surfactant to solubilize the anionic surfactant and to form a liquid surfactant composition. The resulting liquid surfactant composition preferably has an active surfactant content of greater than 40% by weight based on the total weight of the composition, is preferably substantially isotropic at a temperature of about 25° C., is preferably substantially non-flammable and preferably contains substantially no volatile organic components.

### DETAILED DESCRIPTION

When individual active surfactant content values are expressed herein for a surfactant composition as a percentage of the surfactant actives by weight, it refers to the weight of a given surfactant active expressed as a percentage of the total weight of all surfactants actives present in the given composition, excluding any non-surfactant components. Thus, for those compositions made up of 100% active surfactant materials, the weight percentage of a given component expressed as a percentage of surfactant actives would be the same as the weight percentage expressed as a percentage of the total weight of the composition.

In the following description, Tables 1-12 are referred to with regard to specific commercial and exemplary components which may be employed in various combinations in the formulation of the disclosed surfactant compositions. With benefit of this disclosure it will be understood by those of skill in the art that any of the specific compounds, and/or combinations thereof, disclosed in these tables, or materials capable as serving as their functional equivalents, may be employed to the extent they are suitable for use in any of the embodiments disclosed herein, whether otherwise specifically referred to or not.

In the formulation of the disclosed liquid surfactant compositions, one or more nonionic surfactants may be combined with salts and/or acids of anionic surfactants to form concentrated surfactant compositions. As used herein, the “active surfactant content” of a surfactant composition refers to the total weight percentage of surfactant (anionic, nonionic, and cationic) present in a particular composition. The “active detergent content” of a surfactant composition refers to the total weight percentage of surfactants and other detergent-active components, such as hydrotropes. A surfactant composition having an active detergent content of greater than 80% is referred to herein as “high active.” However, advantages may also be achieved with the disclosed compositions by providing substantially isotropic surfactant compositions having active detergent contents of less than 80%. As used herein, “isotropic” means a solution exhibiting non-birefringence under a polarized microscope at the specified temperature.

In the practice of one embodiment of the invention, suitable nonionic surfactants include any nonionic surfactant material that is a liquid at a desired temperature (such as anticipated temperature of shipping, storage and/or use). For example, selected suitable nonionic surfactants may be liquid at room temperature and include, for example, such surfactants which exist in a liquid form within a temperature range of at least from about 10° C. to about 40° C., alternatively of at least from about 20° C. to about 30° C., and alternatively at least about 25° C., with it being understood that the individual surfactants may optionally be liquid at temperature values outside these values as well. It will be understood with benefit of this disclosure that nonionic surfactants which are also liquid at lower and/or greater temperatures than room temperature, or alternatively the temperatures of these ranges are also suitable.

Suitable nonionic surfactants include, but are not limited to, alkyl phenol ethoxylates (including nonylphenol ethoxylates), alcohol ethoxylates, tallow amine ethoxylates, ether amine ethoxylates, ethylene oxide/propylene oxide (“EO-PO”) block copolymers, alcohol EO-PO adducts, and including mixtures of the foregoing. Specific examples include, but are not limited to, nonylphenol ethoxylates such as “SURFONIC® N-95” available from Huntsman Petrochemical Corporation of Austin, Tex. (hereinafter “HPC”) and linear alcohol ethoxylates such as “SURFONIC® L-24-7” available from HPC, and ethoxylated alkyl amines such as SURFONIC® T-15 also available from HPC. Other specific examples include, but are not limited to, nonionic surfactants commercially available from HPC, and other commercial sources.

Specific examples of suitable nonionic surfactants available from HPC include, but are not limited to, surfactants listed in Table 1.

TABLE 1
Examples of Nonionic Surfactants Available from HPC
ALCOHOL ETHOXYLATES

| | |
|---|---|
| Linear Alcohol | L-series Biodegradation, SURFONIC ®® L610-3, |
| Ethoxylates | SURFONIC ® L108/85-5, SURFONIC ® L1270-2, |
| | SURFONIC ® L12/85-2, SURFONIC ® L12-2.6, |
| | SURFONIC ® L12-6, SURFONIC ® L12-8, SURFONIC ® |
| | L24-1.3, SURFONIC ® L24-2, SURFONIC ® L24-3, |
| | SURFONIC ® L24-4, SURFONIC ® L24-4.4, SURFONIC ® |
| | L24-5, SURFONIC ® L24-7, SURFONIC ® L24-9, |
| | SURFONIC ® L24-12, SURFONIC ® L24-17, SURFONIC ® |
| | L24-22, SURFONIC ® L46-7, SURFONIC ® L68-18, |
| | SURFONIC ® HF-055 |
| Branched Alcohol | SURFONIC ® AE-2, SURFONIC ® DA-4, SURFONIC ® DA- |
| Ethoxylates | 6, SURFONIC ® EH-2, SURFONIC ® TDA-3B, SURFONIC ® |
| | TDA-6, SURFONIC ® TDA-8, SURFONIC ® TDA-8/90, |
| | SURFONIC ® TDA-8.4, SURFONIC ® TDA-9, SURFONIC ® |
| | TDA-11, SURFONIC ® DDA-3, SURFONIC ® DDA-6, |
| | SURFONIC ® DDA-8, SURFONIC ® DDA-12 |

ALKYLPHENOL ETHOXYLATES

| | |
|---|---|
| Nonylphenol | SURFONIC ® N-Series Biodegradation, SURFONIC ® N-10, |
| Ethoxylates | SURFONIC ® N-31.5, SURFONIC ® N-40, SURFONIC ® N- |
| | 60, SURFONIC ® N-70, SURFONIC ® N-80, SURFONIC ® |
| | N-85, SURFONIC ® N-95, SURFONIC ® N-100, |
| | SURFONIC ® N-102, SURFONIC ® N-110, SURFONIC ® N- |
| | 120, SURFONIC ® N-150, SURFONIC ® NB-158, |
| | SURFONIC ® NB-189, SURFONIC ® N-200, SURFONIC ® |
| | N-300, SURFONIC ® NB-307, SURFONIC ® N-400, |
| | SURFONIC ® NB-407, SURFONIC ® N-500, SURFONIC ® |
| | NB-507, SURFONIC ® N-550, SURFONIC ® NB-557, |
| | SURFONIC ® N-700, SURFONIC ® N-800, SURFONIC ® N- |
| | 1000, SURFONIC ® NB-1007 |
| Octylphenol | SURFONIC ® OP-15, SURFONIC ® OP-35, SURFONIC ® |
| Ethoxylates | OP-50, SURFONIC ® OP-70, SURFONIC ® OP-100, |
| | SURFONIC ® OP-120, SURFONIC ® OPB-167, |
| | SURFONIC ® OPB-307, SURFONIC ® OP-400, |
| | SURFONIC ® OPB-407, SURFONIC ® OPB-707 |
| Dodecylphenol | SURFONIC ® DDP-40, SURFONIC ® DDP-50 (draft), |
| Ethoxylates | SURFONIC ® DDP-60, SURFONIC ® DDP-70 (draft), |
| | SURFONIC ® DDP-80 (draft), SURFONIC ® DDP-90, |
| | SURFONIC ® DDP-100 (draft), SURFONIC ® DDP-110 |
| | (draft), SURFONIC ® DDP-120 (draft), SURFONIC ® DDP- |
| | 140 (draft) |
| Dinonylphenol | SURFONIC ® DNP-15 (draft), SURFONIC ® DNP-20 (draft), |
| Ethoxylates | SURFONIC ® DNP-40 (draft), SURFONIC ® DNP-70 (draft), |
| | SURFONIC ® DNP-80 (draft), SURFONIC ® DNP-100 |
| | (draft), SURFONIC ® DNP-140 (draft), SURFONIC ® DNP- |
| | 180 (draft), SURFONIC ® DNP-240 (draft), SURFONIC ® |
| | DNP-490 (draft), SURFONIC ® DNP-550 (draft), |
| | SURFONIC ® DNP-700 (draft), SURFONIC ® DNP-1000 |
| | (draft), SURFONIC ® DNP-1500 (draft) |

ALCOHOL OR ALKYLPHENOL ALKOXYLATES (EO/PO)

SURFONIC ® LF-47, SURFONIC ® LF-18, SURFONIC ® LF-
37, SURFONIC ® LF-40, SURFONIC ® LF-41, SURFONIC ®
LF-47, SURFONIC ® LF-50, SURFONIC ® LF-68,
SURFONIC ® LF-0312, SURFONIC ® JL-80X, SURFONIC ®
JL-80X-B1, SURFONIC ® JL-25X, SURFONIC ® P-1,
SURFONIC ® P-3, SURFONIC ® P-5, SURFONIC ® P-6,
Defoamer PM, SURFONIC ® L4-29X

EO/PO BLOCK COPOLYMERS

SURFONIC ® POA-L42, SURFONIC ® POA-L44,
SURFONIC ® POA-L61, SURFONIC ® POA-L62,
SURFONIC ® POA-L62LF, SURFONIC ® POA-L64,
SURFONIC ® POA-L81, SURFONIC ® POA-L101,
SURFONIC ® POA-25R2, SURFONIC ® POA-LF1,
SURFONIC ® POA-LF2, SURFONIC ® POA-LF5

POGOL PEGS

Pogol 200, Pogol 300, Pogol 400, Pogol 500, Pogol 600, Pogol
900, Pogol 1000, Pogol 1005, Pogol 1450, Pogol 1457

Examples of suitable nonionic surfactants also include products available from Witco division of Crompton Corporation (hereinafter “Witco”). Such products include, for example, WITCONOL™ linear ethoxylated alcohols, DESONIC™ alkylphenol ethoxylates, WITCAMIDE® and VARAMIDE™ amide ether condensates, and VARONIC™ cocoamine and tallow amine ethoxylates. Some specific examples of such surfactants are listed in Table 2. Other nonionic materials include, but are not limited to, alcohol ethoxylates (“AE”), nonylphenol ethoxylates (“NPE”), ethoxylated mono and diglycerides, ethoxylated amines, amides, amine oxides and specialty blends.

TABLE 2
Examples of Amphoteric and Nonionic Surfactants
Available from Witco
AMPHOTERIC AND NONIONIC SURFACTANTS

| Product Tradename | Description |
|---|---|
| REWOTERIC ® AMB | Cocoamidopropyl Dimethyl Betaine |
| 12P | |
| REWOTERIC ® AM B14 | Cocoamidopropyl Dimethyl Betaine |
| REWOTERIC ® AM 2C 2 | Disodium Coco Amphodiacetate |
| REWOTERIC ® AM TEG | Tallow Glycinate |
| REWOTERIC ® AM CAS | Cocoamidopropyl Hydroxy Sultaine |
| REWOTERIC ® AM | Coco Amphopropionate |
| KSF40 | |
| REWOTEPIC ® AMV | Sodium Capryloamphoacetate |
| WITCAMIDE ® 128T | Cocoamide DEA |
| WITCONOL ® 12-3 | C12/C15 Alcohol Ethoxylate (3EO) |
| WITCONOL ® 12-7 | C12/C15 Alcohol Ethoxylate (7EO) |
| WITCONOL ® 12-6 | C12/C14 Alcohol Ethoxylate (6EO) |
| DESONIC ® 9N | Nonylphenol + 9 EO |
| VARONIC ® K-205 | PEG 5 Cocamine |
| VARONIC ® K-210 | PEG 10 Cocamine |
| VARONIC ® T-210 | PEG 10 Tallow Amine |
| VARONIC ® T-215 | PEG 15 Tallow Amine |

Specific examples of suitable nonionic surfactants available from Stepan Company (hereinafter “Stepan”) include, but are not limited to, surfactants listed in Table 3.

TABLE 3
Examples of Nonionic Surfactants Available from Stepan
ALKOXYLATES

| | | | | |
|---|---|---|---|---|
| HPC ® 4 | Nonyl Phenol Ethoxylate | 100 | Liquid | Detergents and emulsifiers |
| MAKON ® 6 | Nonyl Phenol Ethoxylate | 100 | Liquid | differing in ethylene oxide |
| MAKON ® 8 | Nonyl Phenol Ethoxylate | 100 | Liquid | content. Makon 4 is the most |
| MAKON ® 10 | Nonyl Phenol Ethoxylate | 100 | Liquid | oil-soIub~e. Makon 12 is the |
| MAKON ® 12 | Nonyl Phenol Ethoxylate | 100 | Liquid | least oil soluble. |
| MAKON ® OP-9 | Octyl Phenol Ethoxylate | 100 | Liquid | Emulsifier, detergent |
| | | | | dispersant, and wetting agent. |
| MAKON ® NF-5 | Polyalkoxylated Amide | 100 | Liquid | Non-foaming wetting agents |
| MAKON ® NF-12 | Polyalkoxylated Aliphatic | 100 | Liquid | for mechanical dishwash |
| | Base | | | detergents and metal cleaning. |
| AMIDOX ® L-5 | PEG-6 Lauramide | 100 | Solid | Emulsifiers, detergents, wetting |
| AMIDOX ® C-5 | PEG-6 Cocamide | 100 | Liquid | agents that have some of the |
| | | | | properties of both |
| | | | | alkanolamides and nonionic |
| | | | | type surfactants. |
| BIO-SOFT ® EA-8 | Alkoxylated Alcohol | 100 | Liquid | Emulsifiers and detergents |
| BIO-SOFT ® EA-10 | Alkoxylated Alcohol | 100 | Liquid | differing in ethylene oxide |
| NEUTRONYX ® 656 | Nonyl Phenol Ethoxylate | 100 | Liquid | Detergent and emulsifier for |
| | | | | hard surface detergents. |

In one embodiment, an amount of nonionic surfactant sufficient to solubilize the anionic surfactant may be employed. For achieving lower relative viscosities, a weight amount of nonionic surfactant greater than anionic surfactant may be employed, although this is not necessary to achieve the benefit of the disclosed methods and compositions. For example, in one embodiment a weight ratio of nonionic surfactant to anionic surfactant may range from about 10:1 to about 1:10, alternatively from about 10:1 to about 5:1, alternatively from about 1:10 to about 1:5, alternatively from about 1:1 to about 3:1, and in one particular embodiment may be about 3:1, although ratios outside these given ranges are also possible.

In alternative embodiments of the disclosed liquid surfactant compositions, nonionic surfactant(s) may be present in an amount of from about A% to about B% by weight of total weight of surfactant composition while at the same time anionic surfactant(s) may be present in an amount of from about C% to about D% by weight of total weight of surfactant composition; where for each respective embodiment the value of A may be independently selected from the range of values of from 35 to 79, and a corresponding value of B may be independently selected from the range of values of from 36 to 80 with the proviso that A is less than B for a given embodiment; and where for each respective embodiment the value of C may be independently selected from the range of values of from 5 to 39, and a corresponding value of D may be independently selected from the range of values of from 6 to 40 with the proviso that C is less than D for a given embodiment. For example, in an embodiment where A=60, B=80, C=20 and D=40, a surfactant composition including an amount of nonionic surfactant/s of from about 60% to about 80% by weight of the total weight of the composition, and an amount of anionic surfactant of from about 20% to about 40% by weight of the total weight of the composition would be represented. Similarly, in an embodiment where A=35, B=80, C=15 and D=40, a surfactant composition including an amount of nonionic surfactant(s) of from about 35% to about 80% by weight of the total weight of the composition, and an amount of anionic surfactant of from about 15% to about 40% by weight of the total weight of the composition would be represented. It will be understood with benefit of this disclosure, that in any of the above-given embodiments where the total of nonionic surfactant content and anionic surfactant content is less than 100%, then the balance of the surfactant composition may be made up of other non-surfactant components described elsewhere herein (e.g., water, hydrotrope, etc.); however, compositions according to the invention are devoid from the presence of oxidizing agents, such as hydrogen peroxide and organic peroxides. Using the possible values of A, B, C and D, amount of such other components in a surfactant composition may vary from 0 to about 60% by weight of the total weight of the composition. Thus, where nonionic surfactant content is about 80% by weight of the total weight of the composition and anionic surfactant content is about 15% by weight of the total weight of the composition, then the content of non-surfactant component may be about 5% by weight of the total weight of the composition.

In separate respective and alternative embodiments, nonionic surfactant or a mixture of nonionic surfactants may be present to solubilize an anionic surfactant or mixture of anionic surfactants in a surfactant composition in an amount of from about x% to about y% of the surfactant actives by weight, where for each respective embodiment the value of x may be independently selected from the range of values of from 9 to 90, and a corresponding value of y may be independently selected from the range of values of from 11 to 91 with the proviso that x is less than y for a given embodiment. For example, in an embodiment where x=50 and y=66, a surfactant composition including an amount of nonionic surfactant(s) of from about 50% to about 66% of the surfactant actives by weight would be represented. In such embodiments, anionic surfactant(s) may make up the balance of surfactant actives, and the overall active surfactant content (i.e., total of nonionic surfactant(s) content and anionic surfactant/s content) of a given surfactant composition may be as expressed elsewhere herein.

In one embodiment, suitable anionic surfactants may be characterized as having pKa values less than 7, although anionic surfactants having other pKa values are also suitable. Examples of suitable anionic surfactants include, but are not limited to, linear and/or branched chain alkylbenzene sulfonates, alkyl sulfates, alcohol sulfates, ether sulfates, secondary alkyl sulfates, α-olefin sulfonates, phosphate esters, sulfosuccinates, isethionates, carboxylates, mixtures thereof, etc. Most of these surfactants are typically sold in the form of a sodium salt.

In one exemplary embodiment, one or more alkylbenzene sulfonate/s may be employed as anionic surfactants. In this regard, alkylbenzene sulfonate compounds having varying molecular weights, alkyl chain length and alkyl chain phenyl location combination may be employed. Examples of such compounds may be found in U.S. Pat. No. 3,776,962; U.S. Pat. No. 5,152,933; U.S. Pat. No. 5,167,872; Drazd, Joseph C. and Wilma Gorman, “Formulating Characteristics of High and Low 2-Phenyl Linear Alkylbenzene Sulfonates in Liquid Detergents,” JAOCS, 65(3):398-404, March 1988; Sweeney, W. A. and A. C. Olson, “Performance of Straight-Chain Alkylbenzene Sulfonates (LAS) in Heavy-Duty Detergents,” JAOCS, 41:815-822, December 1964.; Drazd, Joseph C., “An Introduction to Light Duty (Dishwashing) Liquids Part I. Raw Materials,” Chemical Times & Trends, 29-58, January 1985; Cohen, L. et al., “Influence of 2-Phenyl Alkane and Tetralin Content on Solubility and Viscosity of Linear Alkylbenzene Sulfonate,” JAOCS, 72(1):115-122, 1995; Smith, Dewey L., “Impact of Composition on the Performance of Sodium Linear Alkylbenzenesulfonate (NaLAS),” JAOCS, 74(7):837-845, 1997; van Os, N. M. et aL., “Alkylarenesulphonates: The Effect of Chemical Structure on Physico-chemical Properties,” Tenside Surf Det., 29(3):175-189, 1992; Moreno, A. et al., “Influence of Structure and Counterions on Physicochemical Properties of Linear Alkylbenzene Sulfonates,” JAOCS, 67(8):547-552, August 1990; Matheson, K. Lee and Ted P. Matson, “Effect of Carbon Chain and Phenyl Isomer Distribution on Use Properties of Linear Alkylbenzene Sulfonate: A Comparison of ‘High’ and ‘Low’ 2-Phenyl LAS Homologues,” JAOCS, 60(9):1693-1698, September 1983; Cox, Michael F. and Dewey L. Smith, “Effect of LAB composition on LAS Performance,” INFORM, 8(1):19-24, January 1997; U.S. patent application Ser. No. 08/598,692 filed on Feb. 8, 1996, U.S. patent application Ser. No. 09/141,660 filed on Aug. 28, 1998, and U.S. patent application Ser. No. 09/143,177 filed on Aug. 28, 1998; all of the foregoing references, patent applications, and issued patents being incorporated herein by reference in their entirety.

In one embodiment, alkylbenzene sulfonate compounds used in accordance with the disclosed compositions and methods and having the characteristics described herein include those having a linear alkyl group. Typically linear alkyl chain lengths are between about 8 and about 16 carbon atoms, although greater and lesser lengths are possible.

One specific low 2-phenyl alkylbenzene sulfonate composition is a sulfonate prepared from a linear alkyl benzene known as ALKYLATE 225™ (commercially available from HPC). Other examples of suitable linear alkylbenzenes for preparing linear alkyl benzene sulfonates include, but are not limited to, ALKYLATE 215™, ALKYLATE 229™, ALKYLATE H230L™, and ALKYLATE H230H™, also available from HPC. Suitable processes for sulfonating such linear alkyl benzenes include, but are not limited to, those employing an air/SO₃ sulfonator or chlorosulfonic acid.

Examples of other suitable anionic surfactants include, but are not limited to, alkyl sulfates, ether sulfates, secondary alkyl sulfates, α-olefin sulfonates, xylene sulfonates, alcohol sulfates, phosphate esters, napthalene sulfonates, sulfosuccinates, isethionates, carboxylates, etc.

Specific examples of other suitable anionic surfactants include, but are not limited to, the surfactants listed in Table 4 and available from HPC.

TABLE 4
Examples of Anionic Surfactants Available from HPC

| Anionic Surfactant Type | Product Name |
|---|---|
| DETERGENT | Nonasol LD-50, Nonasol N4SS, |
| SULFATES/SULPONATES | Sulfonic Acid LS, |
| | SURFONIC ® SB-N4AS ®, |
| | SURFONIC ® SNS-60 ®, |
| | SURFONIC ® |
| | SNS-40 ® |
| PHOSPHATE ESTERS | Agphos ™ 7140, |
| | SURFONIC ® PE-1168, |
| | SURFONIC ® PE-1178 ®, |
| | SURFONIC ® |
| | PE ®, SURFONIC ® PE-1218 ®, |
| | SURFONIC ® PE-2188 ®, |
| | SURFONIC ® PE-2208 ®, |
| | SURFONIC ® PE-2258 ®, |
| | SURFONIC ® PE-JV-05-015 ®, |
| | SURFONIC ® PE-BP-2 ®, |
| | SURFONIC ® PE-25/97 ® |
| SULFONATES | SXS-40, PSA, XSA-80, XSA-90, |
| | XSA-95 |
| SULFOSUCCINATES | SURFONIC ® DOS-40; |
| | SURFONIC ® DOS-60; |
| | SURFONIC ® DOS-70E; |
| | SURFONIC ® DOS-70MS; |
| | SURFONIC ® DOS-75; |
| | SURFONIC ® DOS-75PG |
| ISETHIONATE | SURFONIC ® SI |

Still other specific examples of suitable anionic surfactants include, but are not limited to, the surfactants listed in Table 5 available from Witco Corporation, Greenwich, Conn. USA.

TABLE 5
Examples of Anionic Surfactants Available from Witco

| PRODUCT | DESCRIPTION |
|---|---|
| WITCONATE ™ | Alkylbenzene, Alpha Olefin, and Xylene |
| | Sulfonates |
| WITCO ® | Alkylbenzene Sulfonic Acid and Slurries |
| WITCOLATE ™ | Alcohol Sulfates and Ether Sulfates |
| EMPHOS ™ | Phosphate Esters |
| PETRO ® | Naphthalene Sulfonate Hydrotopes |
| EMCOL ® | Speciality Anionic Surfactants |
| Witco Workhorse | Linear Alkyl Benzene Sulfonates (LAS); |
| Surfactants/Hydrotropes | Alcohol Sulfates (AS); Alcohol Ether Sulfates |
| Anionics | (AES), Alpha Olefin Sulfonates (AOS), |
| | Sodium Xylene Sulfonate (SXS) |
| Witco Specialty | Sulfosuccinates, Ether Carboxylates, |
| Surfactants/Hydrotropes | Naphthalene Sulfonates, Phosphate Esters |
| Anionics | |
| WITCONATE 90 Flakes | Sodium Alkylbenzene Sulfonate |
| WITCONATE Slurries | Sodium Alkylbenzene Sulfonate |
| WITCONATE 1298SA | Sodium Alkylbenzene Sulfonic Acid |
| WITCONATE 45 Liquid | Sodium Alkylbenzene Sulfonate & SXS |
| WITCONATE 60T Liq. | TEA-Dodecylbenzene Sulfonate |
| WITCOLATE WAC-LA | Sodium Lauryl Sulfate |
| WITCOLATE A Powder | Sodium Lauryl Sulfate |
| EMCOL 4161L | Sodium oleylalkanolamido sulfosuccinate |
| WITCOLATE SE-5 | Sodium Pareth-25 (Ether) Sulfate (3EO) |
| WITCOLATE LES-60C | Sodium Lauryl Ether Sulfate (3EO) |
| WITCOLATE AE-3 | Ammonium Pareth-25 (Ether) Sulfate |
| WITCOLATE LES-60a | Ammonium Laureth (Ether) Sulfate |
| WITCOLATE ES-370 | Sodium Lauryl Ether Sulfate (3EO) |
| WITCOLATE AOS | Sodium Alpha Olefin Sulfonate |
| WITCOLATE AOK | Sodium Alpha Olefin Sulfonate |
| WITCONATE 93S | Isopropylamine of Dodecylbenzene Sulfonate |
| WITCONATE P-1059 | Isopropylamine of Dodecylbenzene Sulfonate |
| EMCOL CNP 110 | Alkylaryl Ethoxylated Carboxylate |
| EMCOL CLA 40 | C12-14 Ethoxylated Carboxylic Acid |
| WITCONATE SXS Liq. | Sodium Xylene Sulfonate |
| WITCONATE SXS FL | Sodium Xylene Sulfonate |
| WITCONATE NAS-8 | Sodium Octyl Sulfonate |
| PETRO BA | Sodium Alkyl Naphthalene Sulfonate |
| PETRO BAF | Sodium Alkyl Naphthalene Sulfonate |
| Ether Carboxylate | Emcol CNP-40, Emcol CNP-60, Emcol CNP- |
| Anionic Surfactant | 100, Emcol CNP-110, Emcol CNP-120, Emcol |
| | CLA-40, Emcol CBA-50, Emcol CBA-60, |
| | Emcol CBA-100, Structure: |
| | 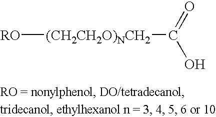 |

Still other specific examples of anionic surfactants include, but are not limited to, the surfactants listed in Table 6 and available from Stepan Company.

TABLE 6
Examples of Anionic Surfactants Available from Stepan

| Product | Chemical Description |
|---|---|
| ALPHA SULFO | |
| METHYL ESTERS | |
| Alpha-Step ML-40 ® | Sodium methyl 2-sulfolaurate and |
| | disodium 2-sulfolaurate |
| Alpha-Step MC-48 ® | Sodium methyl 2-sulfo C₁₂-C₁₈ |
| | ester and disodium 2-sulfo C₁₂-C₁₈ |
| | fatty acid salt |
| ALKYLBENZENE | |
| SULFONATES | |
| Bio-Soft D-40 ® | Sodium alkylbenzene sulfonate, linear |
| Bio-Soft D-62 ® | Sodium alkylbenzene sulfonate, linear |
| Bio-Soft N-300 ® | TEA-Dodecylbenzene sulfonate |
| NACCONOL 40G ® | Sodium alkylbenzene sulfonate, linear |
| NACCONOL 90G ® | Sodium alkylbenzene sulfonate, linear |
| Ninate 401 ® | Calcium alkylbenzene sulfonate, |
| | branched |
| Bio-Soft N-411 ® | Amine alkylbenzene sulfonate, linear |
| SULFONIC ACIDS | |
| Bio-Soft S-100 ® | Alkylbenzene sulfonic acid, linear |
| Bio-Soft S-126 ® | Alkylbenzene sulfonic acid, linear |
| Stepantan H-100 ® | Alkylbenzene sulfonic acid, branched |
| HYDROTROPES | |
| Stepanate SXS ® | Sodium xylene sulfonate |
| Stepanate AXS ® | Ammonium xylene sulfonate |
| Stepanate SCS ® | Sodium cumene sulfonate |
| PHOSPHATE ESTERS | |
| Cedephos FA-600 ® | Alkyl ether phosphate |
| Stepfac 8170 ® | Alkylaryl ether phosphate |
| SPECIALTIES | |
| Bio-Terge PAS-8S ® | Sodium alkane sulfonate |
| ALKYL SULFATES | |
| Stepanol WA-extra ® | Sodium lauryl sulfate |
| Stepanol WAC ® | Sodium lauryl sulfate |
| Stepanol WA-special ® | Sodium lauryl sulfate |
| Stepanol ME-dry ® | Sodium lauryl sulfate |
| Stepanol AM ® | Ammonium lauryl sulfate |
| Stepanol AM-V ® | Ammonium lauryl sulfate |
| ALKYL ETHER | |
| SULFATES | |
| Steol 4N ® | Sodium laureth sulfate |
| Steol CS-460 ® | Sodium laureth sulfate |
| Steol CA-460 ® | Ammonium laureth sulfate |
| Steol KS-460 ® | Sodium laureth sulfate, modified |
| Steol KA-460 ® | Ammonium laureth sulfate, modified |

It will be understood with benefit of this disclosure by those of skill in the art that the foregoing examples of anionic surfactants are exemplary only, and that other anionic surfactants meeting the criteria set forth herein may also be employed.

In the practice of the disclosed method and compositions, an anionic surfactant (such as an alkylbenzene sulfonate) may include any counterion or cation suitable for neutralization or salt formation with selected anionic surfactant/s. In one embodiment a counterion or cation is typically ammonium or substituted ammonium. In this regard, a substituted ammonium may include, but is not limited to, monoethanol ammonium, diethanol ammonium, triethanol ammonium, or a mixture thereof. In another embodiment, such a counterion or cation may be an alkali metal, an alkaline earth metal, or a mixture thereof. Examples of alkali metals include, but are not limited to, lithium, sodium, potassium, cesium, or a mixture thereof. Examples of alkaline earth metals include, but are not limited to, magnesium, calcium, strontium, barium, or a mixture thereof.

Amounts of anionic surfactant relative to nonionic surfactant have been described above. In addition to nonionic and anionic surfactants, embodiments of the disclosed surfactant compositions may also include a wide variety of other optional ingredients if so desired. Such ingredients are further described herein. It will be understood that the previously given ratios of nonionic to anionic surfactant are suitable whether or not additional optional ingredients are employed. Thus, high active surfactant compositions may be formulated from anionic surfactants and nonionic surfactants in relative amounts as described elsewhere herein and with the addition of other optional ingredients, if so desired. In cases where optional additional ingredients are present, activity of a surfactant composition may fall with the activity ranges described elsewhere herein. In those cases where no additional components are employed, active surfactant content of a surfactant composition may be advantageously about 100%.

In one embodiment, optional detergent enhancement additive/s may be employed. Examples of such enhancers include, but are not limited to, ethoxylated amine surfactants and/or ethoxylated ether amine surfactants. Further information on ethoxylated amine and ethoxylated ether amine enhancers may be found in U.S. Provisional Patent Application Serial No. 60/115,408 filed on Jan. 11, 1999 and entitled “CONCENTRATED LIQUID DETERGENT COMPOSITION”; U.S. Provisional Patent Application Serial No. 60/139,441 filed on Jun. 15, 1999 and entitled “SURFACTANT COMPOSITIONS CONTAINING ALKOXYLATED AMINES”; and U.S. patent application Ser. No. 09/479,436, filed on Jan. 7, 2000, and entitled “SURFACTANT COMPOSITIONS CONTAINING ALKOXYLATED AMINES,” each of which are incorporated herein by reference.

In still another embodiment, nonionic surfactants which are solid at a desired temperature (such as anticipated temperature of shipping, storage and/or use). More specifically, nonionic surfactants may be employed that exist in a solid form at room temperature, alternatively within a temperature range of at least from about 10° C. to about 40° C., alternatively at least from about 20° C. to about 30° C., and alternatively at about 25° C. For example, one or more nonionic surfactants that exist as a solid at room temperature may be employed by adding sufficient liquefier or liquefying compound, such as propylene glycol or polyethylene glycol to liquefy the material.

If so desired, in another embodiment solid anionic surfactant/s (e.g., ether sulfates, etc.) may be dissolved or otherwise mixed with a polar solvent suitable for solvating the surfactant (e.g., water, etc.), prior to combination with other liquid components of a liquid surfactant composition (e.g., liquid nonionic surfactant solution, etc.).

Examples of suitable liquefying compounds include water soluble glycols such as polyethylene glycols, ethylene glycol, propylene glycol and ethylene glycol mixture, mixtures thereof, etc. Exemplary suitable polyethylene glycol compounds include, but are not limited to, polyethylene glycol compounds having a molecular weight of between about 100 and about 1000, alternatively between 200 and about 2000. Specific examples include one or more polyethylene glycol solubility enhancers having between about 1 and about 20, alternatively between about 3 and about 6 ethylene glycol monomers joined by ether linkages. Specific examples of such polyethylene glycol compounds include, but are not limited to, propylene glycol and/or polyethylene glycol products marketed by HPC under the trade name POGOL®. In the case of POGOL® compounds, the numeric designation indicates the average molecular weight of the polyethylene glycol compounds. Specific examples include, but are not limited to, POGOL® 200, POGOL® 300, POGOL® 400, POGOL® 500, POGOL® 600, POGOL® 900, POGOL® 1000, POGOL® 1005, POGOL® 1450, and POGOL® 1457, available from HPC. In one embodiment, an amount of liquefier compound sufficient to obtain a relatively low viscosity liquid is employed (e.g., equal to or less than about 1000 centipoise), although greater or lesser amounts are also possible.

In the practice of the disclosed compositions and methods, a liquefying compound may be present in an amount of from about 1% to about 20% by weight of total weight of composition, alternatively from about 5% to about 10% by weight of total weight of composition. Such liquefying compounds may be employed with solid nonionic surfactants such as SURFONIC® N-200 or SURFONIC® L46-12, or mixtures thereof. In such compositions, the solid nonionic surfactants are typically employed in the same weight ratio relative to anionic surfactants previously described. For example incorporation of about 10% by weight propylene glycol liquefier with anionic surfactant and nonionic surfactant that is solid at room temperature would result in an about 90% active surfactant composition.

In one embodiment, the disclosed anionic surfactant/nonionic surfactant compositions, high active concentrated surfactant compositions may have an active surfactant content of greater than 40% by weight of total composition weight, alternatively from about 40% to about 100%, and alternatively may be equivalent to each and every individual integer represented between 41% and 100%, (including 100%), by weight of total composition weight. Further, in other exemplary embodiments, possible active surfactant content ranges of the disclosed surfactant compositions may be expressed as being independently any number in the range from X% to Y% by weight of total composition, wherein X is independently any number between 41 to 99, and wherein Y is independently any number between 42 to 100, with the proviso that for any given combination of X and Y, Y is greater than X. For example, in one embodiment where X has a value of 45 and Y has a value of 65, the active surfactant content range of the surfactant composition is from about 45% to about 65%.

In still other exemplary embodiments, the disclosed surfactant compositions may be formulated to have an active detergent content of greater than 50% by weight of total composition, alternatively greater than 60% by weight of total composition, alternatively greater than 70% by weight of total composition, alternatively greater than 78% by weight of total composition, alternatively greater than 80% by weight of total composition, alternatively greater than or equal to about 80% by weight of total composition; alternatively greater than 85% by weight of total composition weight, alternatively greater than 90% by weight of total composition, alternatively greater than about 95% by weight of total composition, with it being understood that the upper limit of these given ranges is 100% by weight of total composition weight. According to the invention, a liquid surfactant composition is provided which may have an active surfactant content of between 70.00% and 99.99%, including every hundredth percentage therebetween, by weight based upon the total weight of the liquid surfactant composition. According to one form of the invention, a composition according to the invention contains water in any amount between 0.01 and 10.00% by weight based upon the total weight of said composition, including every hundredth percentage therebetween. Compositions according to one preferred form of the invention contain no peroxides, as the inclusion of such could lead to compositions which evolve gas owing to the de-composition of such peroxides, and formation of gas in containers in which the inventive compositions are stored, as the de-composition of peroxides by tiny dust (or metal, as in the cases when steel drums are used) particles which serve as nucleation sites for peroxide de-composition is well known in the art. Thus, it is desirable that a composition of the invention contain no peroxides, either hydrogen peroxide or any other inorganic peroxides (metallic peroxides) or organic peroxides. A myriad of compounds falling within the previous classes of peroxides are well-known to those skilled in the chemical arts.

Advantageously, the disclosed surfactant compositions may also be formulated to be substantially isotropic over a temperature range of from about 0° C. to about 50° C., alternatively from about 5° C. to about 40° C., alternatively from about 10° C. to about 40° C., alternatively from about 20° C. to about 30° C., and alternatively at 25° C., it being understood that such a composition may also be substantially isotropic at greater and/or lesser temperature values outside these ranges. Such a surfactant composition may also be substantially non-flammable. Such a surfactant composition may also be formulated to be substantially VOC free (i.e., meaning having substantially no volatile organic components), while at the same time possessing these advantageous properties. As used herein, VOCs include, but are not limited to, volatile solvents, ethanol, isopropanol, benzyl alcohol, etc.

If desired, neutralization of anionic surfactants in the disclosed surfactant compositions may be accomplished with the addition of a basic compound. Examples of such optional neutralizing compounds include, but are not limited to, alkanolamines (e.g., monoethanolamine (“MEA”), diethanolamine (“DEA”), triethanolamine (“TEA”), etc.), alkyl amines (e.g., isopropylamine, 2-(2-aminoethoxy)ethanol (HUNTSMAN DGA® agent(etc., ammonium hydroxide, NaOH, KOH, and mixtures thereof. Amounts of neutralizing compound may be any amount suitable for partially or completely neutralizing an anionic surfactant acid. In one embodiment, an amount of neutralizing compound sufficient to neutralize from about 75% to about 90%, alternatively about 75%, of the anionic surfactant is employed, although greater or lesser amounts are also possible. In another embodiment, neutralizing compound may be present in a surfactant composition in an amount of from about 0% to about 9% by weight of total composition weight, alternatively in any amount between 10% and 30% by weight of total composition weight, although greater or lesser amounts may also be present. When so present, a neutralizing compound may be considered as part of the anionic surfactant content of the surfactant composition.

In the formulation of surfactant compositions according to the invention, anionic and nonionic surfactant components may be combined in any manner suitable to solubilize the anionic surfactant component(s) in the nonionic surfactant component(s) to achieve compositions having surfactant activity values as described elsewhere herein. For example, in one embodiment, appropriate amounts of un-neutralized anionic surfactant/s (e.g., acid form of LAS, the sour ester of ether sulfate, etc.) and neutralizing agent/s (e.g., monoethanolamine (“MEA”), NaOH, etc.) may be added to a nonionic surfactant or mixture of nonionic surfactants. Once the so-formed surfactant mixture achieves relatively constant temperature, it may be allowed to cool to form a substantially isotropic composition.

In one exemplary embodiment, a surfactant concentrate composition may be formulated by dissolving from about 15% by weight to about 19% by weight of total weight of surfactant composition of tallow amine ethoxylate salt LAS (e.g., “ALKYLATE 229™” available from HPC, from about 15% by weight to about 19% by weight of total weight of surfactant composition of SURFONIC® T-15, (HPC) from about 0.5% by weight to about 5% by weight of total weight of surfactant composition of MEA neutralizing compound and from about 18% to about 22% by weight of total weight of surfactant composition of water, into from about 33% by weight to about 37% by weight of total surfactant composition of SURFONIC® N-95 (HPC) and from about 6% by weight to about 10% by weight of total weight of surfactant composition of POGOL® 300. The components of such a blend may be adjusted to create a surfactant blend having desired characteristics, such as activity and/or pH, by for example varying the amount of LAS anionic surfactant relative to MEA neutralizing compound (e.g., in one embodiment to have a pH of from about 7.75 to about 8.75, although greater and lesser values are possible). For example, a surfactant concentrate composition known as “SURFONIC® HDL-10” from HPC may be formulated by dissolving about 17.4% by weight of total weight of surfactant composition of “ALKYLATE 229™”, about 17.4% by weight of total weight of surfactant composition of SURFONIC® T-15, about 2.4% by weight of total weight of surfactant composition of MEA neutralizing compound and about 20% by weight of total weight of surfactant composition of water, into about 34.8% by weight of total surfactant composition of SURFONIC® N-95, about 8% by weight of total weight of surfactant composition of POGOL® 300 to make a relatively low viscosity, and about 80% active detergent content blend having a pH of about 8.24 (see Example 1).

In another exemplary embodiment, a surfactant concentrate composition may be formulated by dissolving from about 23% by weight to about 27% by weight of total weight of surfactant composition of the MEA salt of LAS (e.g., ALKYLATE 229™), into from about 73% by weight to about 77% by weight of total surfactant composition of SURFONIC® N-95 to make an about 100% active blend. The components of such a blend may be adjusted to create a surfactant blend having desired characteristics, such as activity and/or pH, by for example varying the amount of LAS anionic surfactant relative to MEA neutralizing compound used to form the MEA salt of LAS (e.g., in one embodiment to have a pH of from about 9.25 to about 10.25, although greater and lesser values are possible). For example, a surfactant concentrate composition known as SURFONIC® HDL-30 may be formulated by dissolving about 25% by weight of total weight of surfactant composition of the MEA salt of LAS, e.g., ALKYLATE 229™ in about 75% by weight of total surfactant composition of SURFONIC® N-95 to make to make a relatively low viscosity, and about 100% active surfactant content blend having a pH of about 9.79 (see Example 2).

It will be understood with benefit of this disclosure that the preceding two embodiments are exemplary only, and that activity values, pH values, number/identity and/or amounts of components may be varied as so desired, including outside the ranges given above for one or more of these parameters to achieve substantially isotropic, relatively low viscosity, liquid surfactant compositions having substantially no VOC content.

If desired, alkoxylated amine surfactants may be combined with nonionic surfactants and salts or acids of anionic surfactants to, for example, form salts between the ethoxylated amine surfactants and the anionic surfactants. Such salts may be formed, for example, via exchange of amine and sodium cations. In one exemplary embodiment, sufficient alkoxylated amine may be employed in conjunction with the neutralization compound to neutralize about 25% of the anionic surfactant. A range of alkoxylated amine surfactants may be used to form the salt. Suitable alkoxylated amines include any ethoxylated amines capable of forming a water soluble salt with an anionic surfactant. Examples include primary, secondary, and tertiary alkoxylated amines, ethoxylate ether amines, and including all mixtures of any of the foregoing. When so desired, alkoxylated amine surfactants may be combined with salts or acids of anionic surfactants to form salts between the ethoxylated amine surfactants and the anionic surfactants. Such salts may be formed, for example, via exchange of amine and sodium cations.

To cite but one exemplary embodiment, a suitable tertiary alkoxylated amine surfactants can consist of a hydrocarbon tail attached to a nitrogen atom. The nitrogen atom has been alkoxylated to give tertiary amine. The tertiary amine is capable of abstracting a proton from a strong acid to form an ammonium salt. The following structure illustrates such a salt formed between an LAS acid and an ethoxylated alkylamine (tertiary):

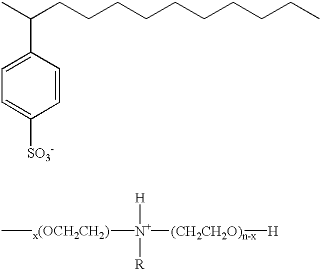

wherein:

R=straight-chain or branched alkyl group having any number of carbon atoms between 7 and 23 carbon atoms;

n=total moles of ethoxylation and is from 2 to 30; and

x=from about 1 to about 29.

In one particular example of this embodiment, an ethoxylated amine may be a tertiary tallow amine ethoxylate in which R=straight-chain or branched alkyl group having from about 16 to about 18 carbon atoms; n=from about 5 to about 20; and x=from about 4 to about 19.

Still other examples of suitable ethoxylated tertiary amines include ethoxylated tertiary amines having some propylene oxide or other alkoxide content. For example, “R” in the previously given tertiary ethoxylated amine formula may be an alkyl group as defined above, or alternatively, a combination of an alkyl group as defined above and an alkoxide group, with the alkyl group being bound to the nitrogen atom. In another example, “R” in the preceding tertiary amine formula may be a combination of an alkyl group as defined above and an alkylaryl, with the alkyl group being bound to the nitrogen atom. In yet another embodiment, an alkoxylated tertiary amine may be of the above formula, with the exception that one or more of the x and/or (n-x) ethylene oxide groups may be replaced with one or more propylene oxide groups, other alkylene oxide groups, or mixtures thereof.

These examples include, but are not limited to, ethoxylated amines of the SURFONIC® series available from HPC including, but not limited to products having designations T-5, T- 10, T- 15, T-20, T-2, and T-50, wherein the numerical suffix indicates the approximate number of moles of ethoxylation per molecule. Other examples of suitable ethoxylated tertiary amines include, but are not limited to, VARONIC® T-215 available from Witco, as well as some compositions available from Akzo Nobel. Other examples of suitable ethoxylate tertiary amines include ethoxylated tertiary amines having some propylene oxide or other alkoxide content. For example “R” in the previously given tertiary ethoxylated amine formula may be an alkyl group as defined above, or alternatively, a combination of an alkyl group as defined above and an alkoxide group, with the alkyl group being bound to the nitrogen atom. In another example, “R” in the preceding tertiary amine formula may be a combination of an alkyl group as defined above and an alkylaryl, with the alkyl group being bound to the nitrogen atom. In yet another embodiment, an alkoxylated tertiary amine may be of the above formula, with the exception that one or more of the x and/or (n-x) ethylene oxide groups may be replaced with one or more propylene oxide groups, other alkylene oxide groups, or mixtures thereof.

Specific examples of suitable ethoxylated tertiary amines may also be found in Table 7.

TABLE 7
Examples of Ethoxylated Tertiary Amines
Available from Huntsman

| | | Theoretical Molecular | Total Amine |
|---|---|---|---|
| Trademark | Product | Weight | (meq/g) |
| SURFONIC ® | T-2 | 350 | 2.75-3.10 |
| | T-5 | 490 | 1.96-2.13 |
| | T-10 | 710 | 1.37-1.49 |
| | T-12 | 798 | 1.23-1.28 |
| | T-15 | 908 | 1.05-1.12 |
| | T-20 | 1150 | 0.89-0.94 |
| | T-50 | 2470 | .39-.42 |

As shown in Table 7, specific examples of suitable ethoxylated amines include, but are not limited to, ethoxylated amines of the SURFONIC® series available from HPC including, but not limited to those designated as T-2, T-5, T-10, T-15, T-20, and T-50, wherein the numerical suffix indicates approximately the number of moles of ethoxylation per molecule. These tallow-amine-ethoxylates are of the type that may be represented by the formula:

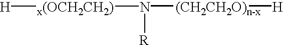

wherein:

R=straight-chain or branched alkyl group having any number of carbon atoms between bout 15 and 20;

n=total number of moles of ethoxylation in the molecule; and

x and (n-x) represent number of ethylene oxide groups in separate chains on the molecule.

Examples of other suitable alkoxylated tertiary amines may be found in Table 8.

TABLE 8
Examples of Other Alkoxylated Tertiary Amines Available
(courtesy Akzo Nobel)

| | | | Equivalent Weight |
|---|---|---|---|
| Trademark | Product | Chemical Description | (Minimum/Maximum) |
| ETHOMEEN ® | C/12 | Ethoxylated (2) | 280/300 |
| Ethoxylated Amines | | Cocoalkylamine | |
| | C/15 | Ethoxylated (5) | 410/435 |
| | | Cocoalkylamine | |
| | C/20 | Ethoxylated (10) | 620/660 |
| | | Cocoalkylamine | |
| | C/25 | Ethoxylated (15) | 830/890 |
| | | Cocoalkylamine | |
| | O/12 | Ethoxylated (2) | 343/363 |
| | | oleylamine | |
| | O/15 | Ethoxylated (5) | 470/495 |
| | | oleylamine | |
| | T/12 | Ethoxylated (2) | 340/360 |
| | | tallowalkylamine | |
| | T/15 | Ethoxylated (5) | 470/495 |
| | | tallowalkylamine | |
| | T/25 | Ethoxylated (15) | 890/950 |
| | | tallowalkylamine | |
| | S/12 | Ethoxylated (2) | 342/362 |
| | | soyaalkylamine | |
| | S/15 | Ethoxylated (5) | 470/495 |
| | | soyaalkylamine | |
| | S/20 | Ethoxylated (1) | 685/725 |
| | | soyaalkylamine | |
| | S/25 | Ethoxylated (15) | 895/955 |
| | | soyaalkylamine | |
| | 18/12 | Ethoxylated (2) | 350/370 |
| | | octadecylamine | |
| | 18/15 | Ethoxylated (5) | 480/505 |
| | | octadecylamine | |
| | 18/20 | Ethoxylated (10) | 690/730 |
| | | octadecylamine | |
| | 18/25 | Ethoxylated (15) | 900/960 |
| | | octadecylamine | |
| | 18/60 | Ethoxylated (50) | 2370/2570 |
| | | octadecylamine | |
| ETHODUOMEEN ® | T/13 | Ethoxylated (3) N-tallow- | 220/250 |
| Ethoxylated Diamines | | 1,3-diaminopropane | |
| | T/20 | Ethoxylated (10) N- | 375/405 |
| | | tallow-1,3- | |
| | | diaminopropane | |
| | T/25 | Ethoxylated (15) N- | 485/515 |
| | | tallow-1,3- | |
| | | diaminopropane | |
| PROPROMEEN ® | C/12 | N-cocoalkyl-1,1′- | 308/318 |
| Propoxylated Amines | | iminobis-2-propanol | |
| | O/12 | N-oleyl-1,1′-iminobis-2- | 371/391 |
| | | propanol | |
| | T/12 | N-tallowalkyl-1,1′- | 373/383 |
| | | iminobis-2-propanol | |

Other examples of specific suitable ethoxylated tertiary amines include, but are not limited to, VARONIC® T-215 available from Witco and compositions available from Akzo Nobel.

Other suitable alkoxylated secondary amines include, but are not limited to, ethoxylated amines having the following formula:

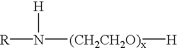

wherein:

R=straight-chain or branched alkyl group having from about 8 to about 22 carbon atoms; and

x=any number between 1 and 30.

In one particular example of this embodiment, an ethoxylated amine may be a secondary tallow amine ethoxylate in which R=straight or branched alkyl group having any number of carbon atoms between 15 and 19; and x=from about 5 to about 20.

Other suitable alkoxylated secondary amines include, but are not limited to, ethoxylated primary amines having the following formula:

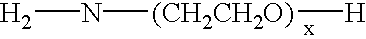

wherein:

x=any value in the range of from 1 to 30.

In one particular example of this embodiment, a primary ethoxylated amine may be one in which x=from 1 to about 21. Examples include, but are not limited to, DGA® Agent available from HPC (2-(2-aminoethoxy) ethanol).

It will be understood with benefit of this disclosure by those of skill in the art that specific types and molecular weights of amines may be selected to fit particular purposes. For example, relatively shorter chain tertiary amine ethoxylates, like SURFONIC® T-2 and T-5 from HPC, may be used to improve mineral oil detergency (e.g., motor oil, grease, etc.), while relatively longer chain tertiary amine ethoxylates, like SURFONIC® T-10 and T-15, may be used to improve trigylceride detergency (e.g., cooking oils, fats, etc.).

Alkoxylated ether amines (such as ethoxylated ether amine) surfactants may also be used, and include those having the following formula:

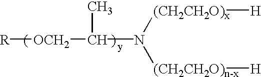

wherein:

R=straight-chain or branched alkyl group having any number of carbon atoms between 7 and 22;

n=total moles of ethoxylation, and is from 1 to about 31;

x=from 2 to about 30; and

y=1 to 30.

In one particular example of this embodiment, an ethoxylated amine may be a tertiary tallow amine ethoxylate in which R=straight-chain or branched alkyl group having any number of carbon atoms between 11 and 15; n=any integer between 4 and 21; x=any integer between 5 and 20; and y=any number between 1 and 21.

Specific examples of suitable alkoxylated ether amines (such as ethoxylated ether amines) etc., may be found in Tables 9 and 10. Such amines may be primary, secondary or tertiary ethoxylated ether amines. Examples include, but are not limited to, ethoxylated ether amines of the SURFONIC® PEA series available from HPC including, but not limited to, SURFONIC® PEA-25 ethoxylated linear polyetheramine, wherein the two digits of the numerical suffix indicates the moles of propoxylation and ethoxylation per molecule respectively. As shown in Table 10, other examples of suitable ethoxylated ether amines include, but are not limited to, E-17-5 available from Tomah Products, Milton, Wis.

TABLE 9
Examples of Ethoxylated Ether Amines Available from Huntsman

| | | Molecular | Total Amine |
|---|---|---|---|
| Trademark | Product | Weight | (meq/g) |
| SURFONIC ® | PEA-25 | 547 | 1.69-1.96 |

As shown in Table 9, specific examples of suitable ethoxylated ether amines include, but are not limited to, an ethoxylated ether amine of the SURFONIC® series available from HPC designated as PEA-25, wherein the numerical suffices indicate moles of propoxylation and ethoxylation, respectively, per molecule. These ethoxylated amines are of the type that may be represented by the formula:

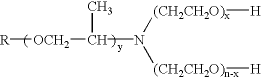

wherein:

R=straight or branched alkyl group having any number of carbon atoms between 11 and 15;

n=total moles of ethoxylation;

y=total moles of propoxylation; and

x and (n-x) represent number of ethylene oxide groups in separate chains on the molecule.

TABLE 10
Examples of Ethoxylated Ether Amines Available from Tomah

| | | | Minimum |
|---|---|---|---|
| | | Molecular | Amine |
| Product | Chemical Description | Weight | Value |
| E-14-2 | Bis-(2-hydroxyethyl) | 310 | 175 |
| | isodecyloxypropyl amine | | |
| E-14-5 | Poly (5) oxyethylene | 445 | 123 |
| | isodecyloxypropyl amine | | |
| E-17-2 | Bis-(2-hydroxyethyl) | 345 | 155 |
| | isotridecyloxypropyl amine | | |
| E-17-5 | Poly (5) oxyethylene | 485 | 112 |
| | isotridecyloxypropyl amine | | |
| E-19-2 | Bis-(2-hydroxyethyl) C₁₂/C₁₅ | 350 | 150 |
| | alkyloxypropyll amine | | |
| E-22-2 | Bis-(2-hydroxyethyl) | 450 | 120 |
| | Octadecyloxypropyl amine | | |

In one embodiment, an amount of ethoxylated amine and/or ethoxylated ether amine sufficient to neutralize the acid functionality of the anionic surfactant may be employed, although greater or lesser amounts are also possible.

Other optional components which may be employed include, but are not limited to, amphoteric surfactants. Typically amphoteric surfactants are supplied in aqueous solution, and therefore, with benefit of this disclosure, those of skill in the art will understand that suitable amounts of amphoteric surfactants may be combined with other surfactants disclosed herein to result in surfactant compositions having the desired active surfactant content as described elsewhere herein. Examples of suitable amphoteric surfactants may be found in U.S. Pat. No. 5,242,615, which is incorporated herein by reference. Specific examples include, but are not limited to, coco dimethylbetaine, coco amidopropylbetaine, coco amino propionic acid, etc. Other specific examples include those disclosed elsewhere herein.

In the formulation and practice of the disclosed compositions and methods, a viscosity modifier may be employed suitable to prevent gel phase formation upon dilution. Examples of suitable modifiers compounds include polyethylene glycols, ethylene glycol, propylene glycol, and mixtures thereof. Examples of suitable polyethylene glycol compounds include, but are not limited to, polyethylene glycol compounds having a molecular weight of between 100 and 1000, alternatively between 200 and 400. Specific examples include one or more polyethylene glycol solubility enhancers having between 1 and 20, alternatively between 3 and 6 ethylene glycol monomers joined by ether linkages. Specific examples of such polyethylene glycol compounds include, but are not limited to, polyethylene glycol products marketed by HPC under the trade name POGOL®, including POGOL® 300. In the case of POGOL® compounds, the numeric designation indicates the average molecular weight of the polyethylene glycol compounds. In one embodiment, an amount of viscosity modifier compound sufficient to obtain a low viscosity liquid is employed.

In another embodiment, by employing one or more water soluble glycols (e.g., propylene glycol, one or more water soluble polyethylene glycols, a mixture thereof, etc.), a surfactant composition may be formulated to exist as a single or substantially homogenous liquid phase, isotropic, (without segregation) at about 40° F. using other components described elsewhere herein, but with substantially no water. In such an embodiment, one or more water soluble glycols may be present to substantially prevent separation or segregation of a composition at, for example, ambient temperatures. Such a formulation may be less corrosive than aqueous solutions and may allow shipping of a composition having substantially no excess weight due to water content.

In one particular embodiment, a surfactant concentrate composition may be formulated by blending together the components listed in Table 11.

TABLE 11

| Concentration Range | |
|---|---|
| (by weight of solution) | Component |
| about 8% to about 35% | LAS Acid |
| up to about 9% | Monoethanolamine |
| up to about 15% | Pogol 300 |
| about 8% to about 35% | SURFONIC ® T-15 |
| About 15% to about 55% | SURFONIC ® N-95* |
| About 10% to about 55% | Water |

*“SURFONIC ® N-95” is a nonylphenol ethoxylate available from HPC having 9.5 moles of ethoxylation and the following formula: C₉H₁₉—C₆H₄—O—(EO)_{9 5}—H (where “EO” represents ethylene oxide).

Although one particular combination of components and weight percentages thereof has been listed in Table 11, it will be understood with benefit of this disclosure that other combinations, other components, as well as other weight percentages (including outside those ranges listed in Table 11), may be employed in the practice of the invention.

Furthermore, although two particular combinations of components are described above, it will be understood with benefit of the disclosure that other combinations, and other components, may be employed in the practice of the invention.

With benefit of this disclosure, the disclosed concentrated surfactant compositions may be employed for a wide variety of uses, including in the formulation of other compositions by the addition of other components known to those of skill in the art As such, the disclosed compositions may also be diluted with one or more solvents, as so needed to fit particular end uses.

In other embodiments, the disclosed compositions may achieve reduced shipping weights and/or provide advantageous handling properties (such as for example in pumping, spraying, mixing, etc.) with little or no dilution. Furthermore, the disclosed concentrated surfactant compositions may be used directly with little or no dilution, for example as for use in an industrial laundry setting where concentrated surfactant composition (including up to 100% active surfactant content composition) is metered into a washing machine directly.

### EXAMPLES

The following examples are illustrative and should not be construed as limiting the scope of the invention or claims thereof.

### Example 1

### High Active Detergent Composition (80% Active Detergent Content)

In this example, a surfactant concentrate is made by blending together the components listed in Table 12. A concentrated detergent was prepared by dissolving 8% by weight polyethylene glycol in 34.8% by weight SURFONIC® N-95. To this was added 17.4% by weight SURFONIC® T-15, 17.4% by weight LAS acid, 2.4% by weight monoethanolamine; and 20% by weight water. The resulting material was a honey-colored fluid liquid having an active detergent content of about 80%. The LAS acid employed was made by sulfonation of “ALKYLATE 229™”, from HPC. “ALKYLATE ₂₂₉™” is a refined mixture of homologs of linear monalkylbenzene prepared by alkylation of benzene with alkyl radicals having chain lengths between 10 and 14, and having an average molecular weight of between about 250 and about 256. Sulfonation typically increases the molecular weight of a compound by about 80.

TABLE 12

| Concentration Range | |
|---|---|
| (by weight of solution) | Component |
| 17.4% | LAS Acid - prepared by sulfonation |
| | of ALKYLATE 229 ™ |
| 2.4% | Monoethanolamine (“MBA”) |
| 8% | POGOL ® 300 |
| 17.4% | SURFONIC ® T-15 |
| 34.8% | SURFONIC ® N-95 |
| 20% | Water |

The physical properties of the blend are shown in Table 13. The solution was isotropic at room temperature (about 25°).

TABLE 13

| Characteristic | Value |
|---|---|
| pH (1%) | 8.24 |
| Solids | 79.8 |
| Viscosity (eps) | 521 |
| Color (Gardner) | 6 |

Advantageously, the blend may be diluted with water with no gel phase formation.

Although one order of component addition is described above, any other order of addition suitable for combination of the components to form a concentrated surfactant liquid composition as described elsewhere herein may be employed. For example, the following sequence of component addition may be used: 1) water; 2) “POGOL® 300” hydrotrope; 3) “SURFONIC® N-95” nonionic surfactant; 4) “ALKYLATE ₂₂₉™” LAS acid; 5) MEA neutralizing compound; and 6) “SURFONIC® T-1 5” nonionic surfactant.

### Example 2

### 100% Active Surfactant Content Composition

In this example, a concentrated surfactant composition blend was prepared by dissolving 18.5% by weight of the “ALKYLATE 229™”-based LAS acid used in Example 1 in 75% by weight SURFONIC® N-95. The salt of LAS was prepared by adding 6.5% by weight MEA. The resulting material was a honey-colored, fluid liquid having an active surfactant content of 100%, a pH (1%) of 9.79, and a viscosity of 753 cps. Observation of the sample under a polarized microscope showed no birefringence at room temperature (about 25° C.).

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed compositions and methods may be utilized in various combinations and/or independently. Thus the invention is not limited to only those combinations shown herein, but rather may include other combinations.

It will be understood with benefit of this disclosure that in structures where x and (n-x) are given herein to represent number of ethylene oxide groups in separate chains on a molecule, values of x and n may vary (for example, within the ranges given), to give a wide range of numerical distributions of ethylene oxide in separate chains of a molecule. However, in one embodiment, n and n-x may be substantially equal (or very close in value), representing a substantially symmetrical or normal distribution of number of ethylene oxide groups between two separate chains of a molecule.

What is claimed is:

1) A liquid surfactant composition that is isotropic over the temperature range from about 0° C. to about 50° C. which is formed from components comprising:
at least one anionic surfactant; and
at least one nonionic surfactant,
wherein the liquid surfactant composition has an active surfactant content of any percentage between 75.00% and 99.99% by weight based on the total weight of said composition, and wherein said composition contains no peroxides.

2) The liquid surfactant composition of claim 1, wherein said liquid surfactant composition has an active surfactant content between 85.00% and 99.95% by weight of the total weight of said composition, and contains no volatile organic components.

3) A liquid surfactant composition according to claim 1 wherein said nonionic surfactant is an ethoxylated amine surfactant described by the formula: 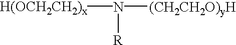
in which R is any straight-chain or branched alkyl group having any number of carbon atoms between 6 and 25, and in which x and y are each independently any whole integer between 1 and 50.

4) The liquid surfactant composition of claim 2, wherein said nonionic surfactant and said anionic surfactant are combined in a nonionic surfactant to anionic surfactant weight ratio of from about 1:1 to about 3:1.

5) The liquid surfactant composition of claim 2, wherein said liquid surfactant composition contains water in any amount between 0.01 and 10.00% by weight based upon the total weight of said composition, including every hundredth percentage therebetween.

6) The liquid surfactant composition of claim 2, wherein said liquid surfactant composition further comprises water, a water soluble glycol, or a mixture thereof.

7) The liquid surfactant composition of claim 2, wherein said anionic surfactant comprises at least one of alkyl benzene sulfonate, alkyl sulfate, alcohol sulfate, ether sulfate, secondary alkyl sulfate, -olefin sulfonates, phosphate esters, sulfosuccinates, isethionates, carboxylates, or a mixture thereof.

8) The liquid surfactant composition of claim 2, wherein said at least one anionic surfactant comprises a salt formed from the acid of a linear alkyl benzene sulfonate and monoethanolamine; and wherein said at least one nonionic surfactant comprises nonylphenol ethoxylate.

9) The liquid surfactant composition of claim 8, wherein said liquid surfactant composition is formed from components comprising said anionic surfactant in an amount of from about 23% to about 27% by weight of the total weight of said composition; and said nonionic surfactant in an amount of from about 73% to about 77% by weight of the total weight of said composition.

10) The liquid surfactant composition of claim 2, wherein said nonionic surfactant comprises at least one of nonylphenol ethoxylate, alcohol ethoxylate, EO-PO block copolymers, or a mixture thereof.

11) The liquid surfactant composition of claim 2, wherein said liquid surfactant composition has a viscosity of less than about 2000 centipoise at 25° C.

12) A non-flammable liquid surfactant composition formed from components comprising:
a) at least one anionic surfactant selected from the group consisting of: alkyl benzene sulfonates, alkyl sulfates, alcohol sulfates, ether sulfates, secondary alkyl sulfates, -olefin sulfonates, phosphate esters, sulfosuccinates, isethionates, and carboxylates, including mixtures thereof; and
b) at least one nonionic surfactant, selected from the group consisting of: nonylphenol ethoxylates, alcohol ethoxylates, EO-PO block copolymers, including mixtures thereof;
c) a salt formed from the acid form of a selected anionic surfactant and a neutralizing compound, said neutralizing compound being selected from the group consisting of: monoethanolamine, diethanolamine, triethanolamine, including mixtures thereof;
wherein said liquid surfactant composition is characterized as:
i) having an active surfactant content of between 71% and 100% by weight of the total weight of the composition;
ii) being isotropic at a temperature of about 25° C.;
iii) having a pH of greater than about 7;
iv) having a viscosity of less than about 2000 centipoise at 25° C.; and wherein said liquid surfactant composition contains no volatile organic components and contains no peroxides.

13) The liquid surfactant composition of claim 12, further comprising at least one of water, propylene glycol, a water-soluble polyethylene glycol, or a mixture thereof.

14) The liquid surfactant composition of claim 12, wherein said anionic surfactant comprises a salt formed from an acid of alkylbenzene sulfonate and said neutralizing compound.

15) The liquid surfactant composition of claim 14, wherein said neutralizing compound comprises monoethanolamine.

16) The liquid surfactant composition of claim 13, wherein said liquid surfactant composition has an active detergent content of greater than 80% by weight of the total weight of said composition.

17) The liquid surfactant composition of claim 15, wherein said liquid surfactant composition has an active surfactant content of greater than about 90% by weight of the total weight of said composition.

18) The liquid surfactant composition of claim 15, wherein said liquid surfactant composition has an active surfactant content of about 100% by weight of the total weight of said composition.

19) The liquid surfactant composition of claim 12, wherein said liquid surfactant composition is formed from components comprising said nonionic surfactant in an amount of from about 60% to about 80% by weight of the total weight of said composition, and said anionic surfactant component in an amount of from about 15% to about 40% by weight of the total weight of said composition; and further comprising water in an amount of from about 0.03% to about 25% by weight of the total weight of said composition.

20) The liquid surfactant composition of claim 12, wherein said liquid surfactant composition has an active surfactant content of about 100% by weight of the total weight of said composition.

21) The liquid surfactant composition of claim 12, wherein said neutralizing compound comprises at least one of monoethanolamine, diethanolamine, triethanolamine, or a mixture thereof.

22) The liquid surfactant composition of claim 20, wherein said surfactant composition is formed from components comprising:
said anionic surfactant in an amount of from about 20% to about 40% by weight of the total weight of the surfactant composition, said anionic surfactant comprising linear alkylbenzene sulfonate salt; and
said nonionic surfactant in an amount of from about 80% to about 60% by weight of the total weight of the surfactant composition.

23) The liquid surfactant composition of claim 22, wherein said nonionic surfactant comprises nonylphenol ethoxylate.

24) The liquid surfactant composition of claim 23, wherein said linear alkyl benzene sulfonate salt is formed from the acid of said linear alkyl benzene sulfonate and monoethanolamine.

25) The liquid surfactant composition of claim 24, wherein said liquid surfactant composition has an active surfactant content of about 100% by weight of the total weight of said composition.

26) The liquid surfactant composition of claim 25, wherein said liquid surfactant composition is formed from components comprising said linear alkyl benzene sulfonate salt in an amount of from about 23% to about 27% by weight of the total weight of the surfactant composition; and said nonylphenol ethoxylate in an amount of from about 73% to about 77% by weight of the total weight of the surfactant composition.

27) A method for preparing a liquid surfactant composition, comprising:
combining at least one nonionic surfactant with at least one anionic surfactant to solubilize said anionic surfactant and to form a liquid surfactant composition having an active surfactant content of between 71% and 100% by weight of the total weight of said composition;
wherein said liquid surfactant composition is isotropic at a temperature of about 25° C.; and
wherein said liquid surfactant composition is non-flammable and contains no volatile organic components.

28) The method of claim 27, wherein said liquid surfactant composition has an active surfactant content of about 100% by weight of the total weight of said composition.

29) The method of claim 28, wherein said nonionic surfactant and said anionic surfactant are combined in a nonionic surfactant to anionic surfactant weight ratio of from about 1:1 to about 3:1.

30) The method of claim 28, wherein said anionic surfactant comprises at least one of alkyl benzene sulfonate, alkyl sulfate, alcohol sulfate, ether sulfate, secondary alkyl sulfate, -olefin sulfonates, phosphate esters, sulfosuccinates, isethionate, carboxylates, or a mixture thereof; and wherein said nonionic surfactant comprises at least one of nonylphenol ethoxylate, alcohol ethoxylate, EO-PO block copolymer, or a mixture thereof.

31) The method of claim 28, wherein said anionic surfactant comprises a salt formed from an acid of said anionic surfactant and a neutralizing compound, said neutralizing compound comprising at least one of monoethanolamine, diethanolamine, triethanolamine, or a mixture thereof.

32) The method of claim 31, wherein said nonionic surfactant comprises nonylphenol ethoxylate, and wherein said neutralizing compound comprises monoethanolamine.

33) The method of claim 32, wherein said method comprises combining a linear alkyl benzene sulfonate salt in an amount of from about 23% to about 27% by weight of the total weight of the surfactant composition, with said nonylphenol ethoxylate in an amount of from about 73% to about 77% by weight of the total weight of the surfactant composition.

34) A liquid surfactant composition formed from components comprising:
at least one anionic surfactant in an amount of from about 15% to about 40% by weight of the total weight of said composition, said anionic surfactant comprising at least one of alkyl benzene sulfonate, alkyl sulfate, alcohol sulfate, ether sulfate, secondary alkyl sulfate, -olefin sulfonate, phosphate ester, sulfosuccinate, isethionate, carboxylate, or a mixture thereof; and
at least one nonionic surfactant in an amount of from about 60% to about 80% by weight of the total weight of said composition, said nonionic surfactant comprising at least one of nonylphenol ethoxylate, alcohol ethoxylate, EO-PO block copolymer, or a mixture thereof;
water in an amount of from about 0% to about 25% by weight of the total weight of said composition;
wherein said liquid surfactant composition has an active surfactant content of between 71% and 100% by weight of the total weight of said composition;
wherein said liquid surfactant composition is isotropic at a temperature of about 25° C.;
wherein said liquid surfactant composition has a pH of greater than about 7;
wherein said surfactant has a viscosity of less than about 2000 centipoise at 25° C.; and
wherein said liquid surfactant composition is non-flammable and
contains no volatile organic components and contains no peroxides.

35) A liquid surfactant composition formed from components comprising:
linear alkyl benzene sulfonate salt in an amount of from about 20% to about 40% by weight of the total weight of the surfactant composition; and
nonylphenol ethoxylate in an amount of from about 80% to about 60% by weight of the total weight of the surfactant composition;
wherein said liquid surfactant composition has an active surfactant content of between 71% and 100% by weight of the total weight of said composition;
wherein said liquid surfactant composition is isotropic at a temperature of about 25° C.;
wherein said liquid surfactant composition has a pH of greater than about 7;
wherein said surfactant has a viscosity of less than about 2000 centipoise at 25° C.; and
wherein said liquid surfactant composition is non-flammable and contains no volatile organic components.
